(19) United States
(12) Patent Application Publication
(10) Pub. No.: US 2012/0216443 A1
(43) Pub. Date: Aug. 30, 2012

(54) COMBINATION SINKER AND BAIT STABILIZER

(76) Inventor: James MERRITT, Whiteville, NC (US)

(21) Appl. No.: 13/403,114

(22) Filed: Feb. 23, 2012

Related U.S. Application Data
(60) Provisional application No. 61/446,432, filed on Feb. 24, 2011.

(51) Int. Cl. A01K 83/06

(52) U.S. Cl. 43/44.81

(57) ABSTRACT

According to the principles of the present invention a combination sinker and bait stabilizer for a fishing hook is provided. The device is intended for use with a fishing hook having a curved shaft and a sharp tip extending from the curved shaft. The device includes an attachment portion including an eye adapted for receiving the curved shaft through the sharp tip and for lying on the curved shaft. The device further includes first and second capture members attached to the attachment portion and spaced apart from each other, the first and second capture members lying in a plane lateral to the plane of the fishing hook and extending upwardly to be inserted into a portion of a soft bait to maintain the soft bait laterally to the fishing hook.

### CROSS REFERENCE TO RELATED APPLICATION

This application claims the benefit of U.S. Provisional Application No. 61/446,432, filed Feb. 24, 2011, which is hereby incorporated by reference.

### FIELD OF THE INVENTION

The present invention relates to a combination sinker and bait stabilizer for a fishing hook.

### BACKGROUND OF THE INVENTION

“Wacky style” fishing is a technique wherein the hook is attached to the center of a plastic bait (worm) such that the worm will flop around while the hook is in the water. While fishing a “wacky style” technique, a weight is typically not used, but instead the weight of the bait itself (infused with salt) and the hook causes the bait to sink.

Fishing a “wacky style” technique in deeper water becomes a problem because of the time it takes for the bait to sink to the bottom of the water. Also, the worm has a tendency to rotate relative to the plane of the hook when fishing a “wacky style” technique, especially if the bait is dropped over vegetation or other obstacles. If the plastic bait is oriented parallel to the plane of the hook, this reduces the chances of catching a fish because most fish will attack the bait from a perpendicular direction. The present invention provides a solution to the above problems.

### SUMMARY OF THE DISCLOSURE

According to the principles of the present invention a combination sinker and bait stabilizer for a fishing hook is provided. The device is intended for use with a fishing hook having a curved shaft and a sharp tip extending from the curved shaft. The device includes an attachment portion including an eye adapted for receiving the curved shaft through the sharp tip and for lying on the curved shaft. The device further includes first and second capture members attached to the attachment portion and spaced apart from each other, the first and second capture members lying in a plane lateral to the plane of the fishing hook and extending upwardly to be inserted into a portion of a soft bait to maintain the soft bait laterally to the fishing hook. The combination sinker and bait stabilizer has a predetermined weight of 1/32 ounce or greater to facilitate sinking of the soft bait in water.

### BRIEF DESCRIPTION OF THE DRAWINGS

FIGS. 1-2 are perspective views of the combination sinker and bait stabilizer of the present invention.

FIG. 3 is a side view of the device of FIG. 1 after the point of the hook has been inserted through the wire attachment.

FIG. 4 is a perspective view of the device of FIG. 1, after it has been attached to the body of a soft plastic bait together with the hook.

FIG. 5 is a perspective view of the combination sinker and bait stabilizer of the present invention according to another embodiment.

### DETAILED DESCRIPTION OF THE INVENTION

The drawings show a combination sinker and bait stabilizer having an attachment portion including an eye for receiving a hook and having one or more capture members that secure the plastic bait in a fixed relationship relative to the plane of the hook. The fishing device of the present invention allows the fisherman to fish a “wacky style” technique while using a sinker weight and while keeping the plane of the hook perpendicular to the longitudinal axis of the bait.

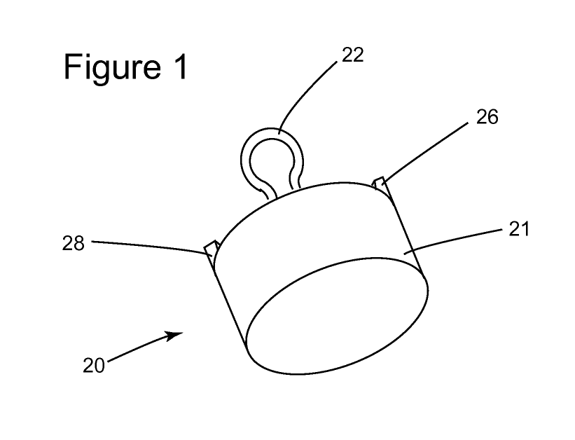

FIGS. 1-4 illustrate a first embodiment of the present invention.

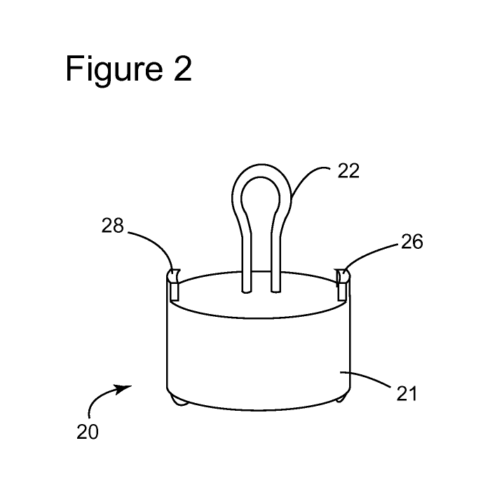

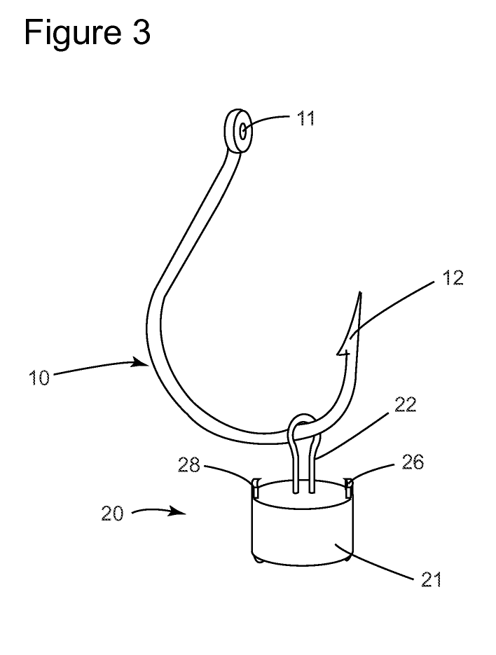

FIGS. 1-2 are perspective views of the combination sinker and bait stabilizer of the present invention. The device 20 includes a body portion 21 which can be hollow or solid and can be any shape, size and weight. The device 20 further includes an attachment portion 22 which forms an eye for receiving a hook (see FIG. 3). The device 20 further includes a first capture member 26 and a second capture member 28 spaced opposite from the first capture member. As shown, the capture members are formed as prongs. It should be understood, that any number of prongs can be used including one, two, three, four, or more. The capture members 26, 28 are attached to the attachment portion 22 and extend up past the top surface of the body portion 21.

As shown in the illustrated embodiment, the body portion 21 includes a planar upper surface. In one embodiment, the upper surface of the body portion 21 can include a longitudinal recess (not shown) for capturing the soft bait.

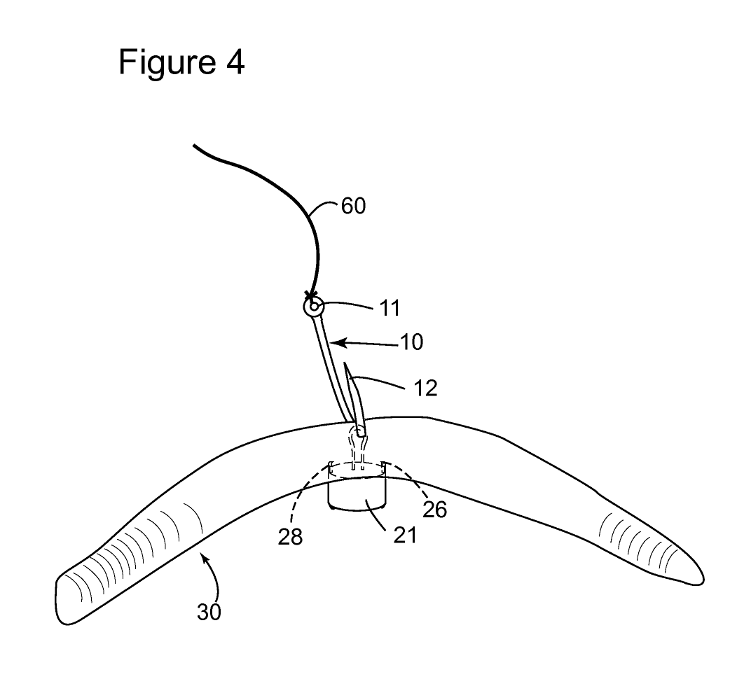

One or both of the capture members 26, 28 can extend orthogonally from the upper surface of the body portion. Each capture member can have the same height or different heights, as measured relative to the upper surface of the body portion 21. Preferably, each capture member has a height that is shorter than the total height of the attachment portion 22. The capture members 26, 28 are adapted to be inserted into the body of plastic bait (see FIG. 4) and as such can include sharp tips and/or barbs. As illustrated in FIG. 2, the eye of the attachment portion and the first and second capture members 26, 28 lie in the same plane. In other embodiments, the first and second capture members 26, 28 can lie in a plane that is offset from the plane of the eye of the attachment portion. In one embodiment, the attachment portion 22 and the first and second capture members 26, 28 are formed of a single piece of metal wire.

FIG. 3 shows a fishing hook 10 for use with the device. The fishing hook 10 includes an eye 11 and a sharp point 12 that is adapted to be inserted through the wire attachment 22 of the weight 20. The fishing hook has a curved shaft.

FIG. 4 shows the method of attaching the assembly of FIG. 3 to a soft plastic bait 30. The soft plastic bait 30 can be any shape and size. First, the user can insert the attachment portion 22 into the body of the bait 30 and advance the eye of the attachment portion 22 through the body of the bait 30 until the first and second capture members 26, 28 are pierced into the body of the bait 30 as well. Next, the user can insert the sharp point 12 of the fishing hook through the surface of the bait 30, through the eye of the attachment portion 22, and out again through the surface of the bait 30. (If the user is not able to view the eye of the attachment portion 22, he can “feel” for its location before inserting the sharp point 12 of the hook through it.) Fishing line 60 is shown being attached to the eye 11 of the fishing hook.

The first and second capture members 26, 28 lie in a plane lateral to the plane of the fishing hook. The capture members 26, 28 extend upwardly to be inserted into a portion of the soft bait 30 to maintain the soft bait laterally to the fishing hook 10.

After the device 20 and fishing hook 10 are attached to the bait 30, the fisherman can drop the bait into deep water and the bait will sink towards the bottom while the bait stays in a fixed relationship relative to the plane of the hook.

The body portion 21 has a predetermined weight of at least 1/32 ounce. For example, the present invention can be sold in weight increments of 1/32, 1/16, 1/8, 3/16 ounce. In another embodiment, the body portion 21 is omitted and instead the attachment portion 22 and first and second capture members 26, 28 are formed of a single piece of metal wire that form a collective weight capable to sink the device in deep water.

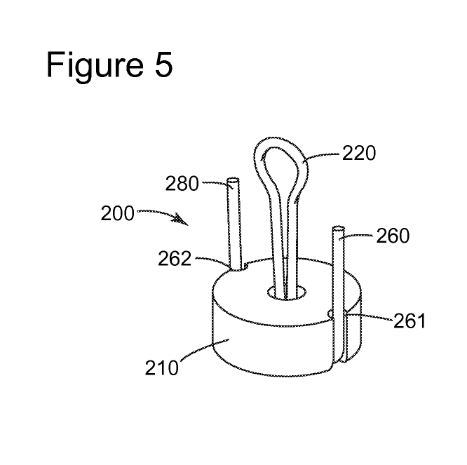

FIG. 5 is a perspective view of the combination sinker and bait stabilizer of the present invention according to another embodiment. In this embodiment the body portion 210 is formed as a separate sinker weight having a through hole through which the attachment portion 220 is inserted. The body portion includes first and second grooves 261, 262 in a side surface and the capture members 260, 280 are positioned in the grooves.

### CONCLUSION

It will thus be seen from the preceding that the problems set forth above are solved in a particularly effective, simple, and inexpensive way, with a considerable advantage to the user.

It is to be understood that although the invention as presented can be used with any type of hook, any type of bait, and any type of fishing. The invention can be used to fish over any kind of structure, through weeds and grass, and at any depth you want, including fresh water and sea water.

The above disclosure is intended to be illustrative and not exhaustive. This description will suggest many modifications, variations, and alternatives may be made by ordinary skill in this art without departing from the scope of the invention. Those familiar with the art may recognize other equivalents to the specific embodiments described herein. Accordingly, the scope of the invention is not limited to the foregoing specification.

What is claimed is:

1. A combination sinker and bait stabilizer for a fishing hook having a curved shaft and a sharp tip extending from the curved shaft, the combination sinker and bait stabilizer comprising:
an attachment portion including an eye adapted for receiving the curved shaft through the sharp tip and for lying on the curved shaft; and
first and second capture members attached to the attachment portion and spaced apart from each other, the first and second capture members lying in a plane lateral to the plane of the fishing hook and extending upwardly to be inserted into a portion of a soft bait to maintain the soft bait laterally to the fishing hook;
wherein the combination sinker and bait stabilizer has a predetermined weight of 1/32 ounce or greater to facilitate sinking of the soft bait in water.

2. The combination sinker and bait stabilizer of claim 1, wherein the eye and first and second capture members lie in the same plane.

3. The combination sinker and bait stabilizer of claim 1, wherein the eye and first and second capture members are formed of a single piece of metal wire.

4. The combination sinker and bait stabilizer of claim 1, further comprising a sinker weight having a through hole through which the attachment portion is inserted.

5. The combination sinker and bait stabilizer of claim 4, wherein the sinker weight has first and second grooves in a side surface of the weight and the capture members are positioned in the grooves.

6. A bait holder for a fishing hook having a curved shaft and a sharp tip extending from the curved shaft, the bait holder comprising:
a body portion having a predetermined sinker weight;
an attachment portion extending upwardly from the body portion, the attachment portion including an eye adapted for receiving the curved shaft of the fishing hook; and
a first capture member extending upwardly from the body portion and spaced from the attachment portion, wherein the first capture member is adapted to be inserted through a portion of a soft bait during use.

7. The bait holder of claim 6, wherein the first capture member and the eye lie in the same plane.

8. The bait holder of claim 6, wherein the attachment portion and the first capture member are formed of a single piece of metal wire.

9. The bait holder of claim 6, wherein the body portion includes a planar upper surface.

10. The bait holder of claim 9, wherein the first capture member extends orthogonally from the upper surface of the body portion.

11. The bait holder of claim 6, wherein the body portion includes an upper surface having a longitudinal recess for capturing the soft bait.

12. The bait holder of claim 6, wherein the height of the first capture member is shorter than the total height of the attachment portion.

13. A bait holder for a fishing hook having a curved shaft and a sharp tip extending from the curved shaft, the bait holder comprising:
a body portion having a predetermined sinker weight;
an attachment portion extending upwardly from the body portion, the attachment portion including an eye adapted for receiving the curved shaft of the fishing hook;
a first capture member extending upwardly from the body portion and spaced from the attachment portion, wherein the first capture member is adapted to be inserted through a portion of a soft bait during use; and
a second capture member extending upwardly from the body portion and being disposed symmetrically to the first capture member, wherein the second capture member is adapted to be inserted through a portion of a soft bait during use.

14. The bait holder of claim 13, wherein the eye and first and second capture members lie in the same plane.

15. The bait holder of claim 13, wherein the first and second capture members and the attachment portion are formed of a single piece of metal wire.

16. The bait holder of claim 13, wherein the body portion includes a planar upper surface.

17. The bait holder of claim 16, wherein the first and second capture members extend orthogonally from the upper surface of the body portion.

18. The bait holder of claim 13, wherein the body portion includes an upper surface having a longitudinal recess for capturing the soft bait.

19. The bait holder of claim 13, wherein the height of each of the first and second capture members is shorter than the total height of the attachment portion.

20. The bait holder of claim 13, wherein the height of the first and second capture members are equal.
